(19) United States
(12) Patent Application Publication
(10) Pub. No.: US 2019/0194497 A1
(43) Pub. Date: Jun. 27, 2019

(54) ADHESIVE, METAL MEMBER ASSEMBLY, AND METHOD FOR MANUFACTURING METAL MEMBER ASSEMBLY

(71) Applicant: 3M INNOVATIVE PROPERTIES COMPANY, St. Paul, MN (US)

(72) Inventors: Takuma Aizawa, Tokyo (JP); Kotaro Shinozaki, Kanagawa-pref. (JP)

(21) Appl. No.: 16/099,025

(22) PCT Filed: May 9, 2017
(86) PCT No.: PCT/US2017/031694

§ 371 Date: Nov. 5, 2018

(30) Foreign Application Priority Data
May 12, 2016 (JP) 2016-096011

(51) Int. Cl. C09J 7/35; C09J 4/06; C09J 7/21; C09J 5/06; B32B 7/12; B32B 15/092; B32B 5/18

(52) U.S. Cl. CPC C09J 7/35; C09J 4/06; C09J 7/21; C09J 5/06; B32B 7/12; B32B 15/092; C09J 2429/00; C09J 2205/114; C09J 2400/24; C09J 2400/263; C09J 2433/00; C09J 2463/00; C09J 2471/00; B32B 5/18

(57) ABSTRACT

An adhesive is provided that has superior bonding strength and that can be beneficially used as a structural adhesive and, when formed into a sheet shape, has superior shape retention. The adhesive includes an acrylic polymer; an epoxy resin in an amount of 80 to 300 parts by mass per 100 parts by mass of the acrylic polymer; at least one type of thermoplastic resin selected from the group consisting of a phenoxy resin and a polyvinyl butyral resin, in an amount of 15 parts by mass or greater per 100 parts by mass of the acrylic polymer; and an epoxy resin curing agent. In such an adhesive, the acrylic polymer is a polymer of monomer components including a (meth)acrylic acid ester having a homopolymer Tg of 80° C. or higher, a nitrogen-containing monomer, and a crosslinking monomer having an epoxy group.

### TECHNICAL FIELD

The present invention relates to an adhesive, a metal member assembly, and a method for manufacturing a metal member assembly.

### BACKGROUND ART

Methods exist for bonding metal members used in automobiles and the like in which the metal members are bonded to each other via an adhesive. For example, in WO/2012/166257, when using two steel plates (an outer steel plate and an inner steel plate) to form a hem flange structure in which an end portion of the outer steel plate is pressed so as to sandwich the inner steel plate, an adhesive sheet is disposed between the outer steel plate and the inner steel plate so as to bond the steel plates to each other.

### SUMMARY OF INVENTION

Superior bonding strength is required in structural adhesives used to bond members such as the metal plates and the like of automobiles, which are responsible for the strength of the structure.

On the other hand, shape retention by which sheet shape is maintained over an extended period of time is also a characteristic required in adhesive sheets. Shape retention is improved by reducing the fluidity of the adhesive, but realizing excellent shape retention by reducing the fluidity of the adhesive while maintaining superior bonding strength is difficult.

One object of the present invention is to provide an adhesive that has superior bonding strength and that can be beneficially used as a structural adhesive and, when formed into a sheet shape, has superior shape retention. Additionally, another object of the present invention is to provide a metal member assembly formed using the adhesive described above, and also provide a method for manufacturing this metal member assembly.

One aspect of the present invention relates to an adhesive including an acrylic polymer; an epoxy resin in an amount of 80 to 300 parts by mass per 100 parts by mass of the acrylic polymer; at least one type of thermoplastic resin selected from the group consisting of a phenoxy resin and a polyvinyl butyral resin, in an amount of 15 parts by mass or greater per 100 parts by mass of the acrylic polymer; and an epoxy resin curing agent. In this adhesive, the acrylic polymer is a polymer of monomer components including a (meth)acrylic acid ester having a homopolymer Tg of 80° C. or higher, a nitrogen-containing monomer, and a crosslinking monomer having an epoxy group.

Another aspect of the present invention relates to a method for manufacturing a metal member assembly including the steps of forming a metal adhered body by disposing the adhesive described above between at least a portion of a first metal member and a second metal member; and obtaining a metal member assembly in which the first metal member and the second metal member are bonded to each other by heating the metal adhered body so as to cure the adhesive.

Yet another aspect of the present invention relates to a metal member assembly including a first metal member; a second metal member; and a bonding member containing a cured product of the adhesive described above. In this metal member assembly, at least a portion of the bonding member is disposed between the first metal member and the second metal member, and bonds the first metal member and the second metal member to each other.

According to the present invention an adhesive can be provided that has superior bonding strength and that can be beneficially used as a structural adhesive and, when formed into a sheet shape, has superior shape retention. Additionally, according to the present invention a metal member assembly formed using the adhesive described above, and a method for manufacturing this metal member assembly can be provided.

### BRIEF DESCRIPTION OF DRAWINGS

FIG. 1 is a perspective view illustrating an adhesive sheet according to an embodiment of the present invention.

FIG. 2 is a drawing illustrating a cross-section taken along line II-II of FIG. 1.

FIGS. 3A and 3B are drawings for explaining an aspect of a method for manufacturing a metal member assembly.

FIGS. 4A and 4B are drawings for explaining another aspect of a method for manufacturing a metal member assembly.

FIG. 5A is an exploded view of a cross-section taken along line I-I of FIG. 4B.

FIG. 5B is an exploded view of the same cross-section in a metal member assembly.

FIGS. 6A to 6C are drawings for explaining an evaluation method of T-peel strength in the examples.

FIGS. 7A to 7C are drawings for explaining an evaluation method of shear strength in the examples.

### DESCRIPTION OF EMBODIMENTS

An adhesive according to an embodiment of the present invention includes an acrylic polymer; an epoxy resin in an amount of 80 to 300 parts by mass per 100 parts by mass of the acrylic polymer; at least one type of thermoplastic resin selected from the group consisting of a phenoxy resin and a polyvinyl butyral resin, in an amount of 15 parts by mass or greater per 100 parts by mass of the acrylic polymer; and an epoxy resin curing agent.

Additionally, in this adhesive, the acrylic polymer is a polymer of monomer components including a (meth)acrylic acid ester having a homopolymer Tg of 80° C. or higher, a nitrogen-containing monomer, and a crosslinking monomer having an epoxy group.

The adhesive according to the present embodiment exhibits superior bonding strength due to the curing by the epoxy resin curing agent and, for example, can be beneficially used as a structural adhesive. Additionally, the adhesive according to the present embodiment has superior shape retention when molded into a sheet shape and, with the adhesive according to the present embodiment, an adhesive sheet can be obtained for which shape loss of the edges or the like does not easily occur when left for an extended period of time. With such an adhesive sheet, precise adhesion is possible and handling is superior.

The main components of the adhesive according to the present embodiment are an acrylic polymer, an epoxy resin, and a predetermined thermoplastic resin.

In the present embodiment, the epoxy resin is responsible for elevating the adhesive strength after curing. If the epoxy resin is compounded at a high proportion, high adhesive strength can be obtained, but there is a tendency in such a case for the moldability and shape retention to be impaired. As such, in the present embodiment, the content of the epoxy resin is set within the range described above.

Additionally, in the present embodiment, the acrylic polymer is responsible for elevating tackiness and moldability before curing. If the acrylic polymer is compounded at a high proportion, the tackiness and moldability before curing will increase, but the adhesive strength may decline. As such, in the present embodiment, the content of the acryl polymer is set within the range described above.

Additionally, in the present embodiment, the thermoplastic resin, namely the phenoxy resin or the polyvinyl butyral resin, has excellent miscibility with both the epoxy resin and the acrylic polymer. Therefore, the thermoplastic resin has the responsibility of increasing the solubility between the epoxy resin and the acrylic polymer and enabling the achievement of both excellent moldability before curing and superior adhesive strength after curing. The content of the thermoplastic resin is set to the range described above in order to obtain remarkable levels of these effects.

In the present embodiment, an amount of the (meth)acrylic acid ester in the monomer components may be from 20 to 60 mass %, based on an entire mass of the monomer components. Thereby, controlling the Tg of the acrylic polymer will be easier, and the moldability, the shape retention, and the tackiness of the adhesive will be excellent.

In the present embodiment, an amount of the nitrogen-containing monomer in the monomer components may be from 20 to 50 mass %, based on the entire mass of the monomer components. Thereby, controlling of the solubility between the acrylic polymer and the epoxy resin will be easier, and the moldability and tackiness of the adhesive, and bonding strength after curing will be excellent.

In the present embodiment, the adhesive may further include a core-shell-type impact modifier. Thereby, the bonding strength of the adhesive after curing will tend to be greater. In cases where using such an adhesive to bond metal members together, the peel strength of the bonded portion will be greater.

In the present embodiment, the adhesive may further include a foaming agent. Due to the fact that the adhesive according to the present embodiment has superior bonding strength, sufficiently high bonding strength can be ensured even in cases where the foaming agent is foamed before curing or during curing, thus causing the adhesive to expand. Therefore, the adhesive according to the present embodiment can be beneficially used as an adhesive that requires expansion.

In the present embodiment, the adhesive may be molded into a sheet shape. As described above, the adhesive according to the present embodiment has superior shape retention when molded into a sheet shape and, therefore, can be beneficially used as an adhesive sheet that is molded into a sheet shape. With such an adhesive sheet, shape loss of the edges or the like does not easily occur when left for an extended period of time and, therefore, precise adhesion is possible and handling is superior. Additionally, the adhesive sheet may be formed long with a width suitable for use and can be used in a roll form and, as a result, storage and transport will be easier. Additionally, the adhesive sheet can be easily formed/shaped to match a use subject and can be easily attached to curved surfaces and the like. Therefore, adhesion area on diverse use subjects can easily be ensured. These adhesive sheets can, for example, be beneficially used as structural adhesives for adhering metal members, resin members, or the like.

A preferred embodiment of the present invention will now be described while referring to the drawings. In the explanations of the drawings, identical elements are given the same reference sign, and duplicate explanations are omitted. Additionally, portions of the drawings are drawn with exaggerated size for the sake of convenience, but such drawings should not be construed to be indications of the actual dimensions of the constituents.

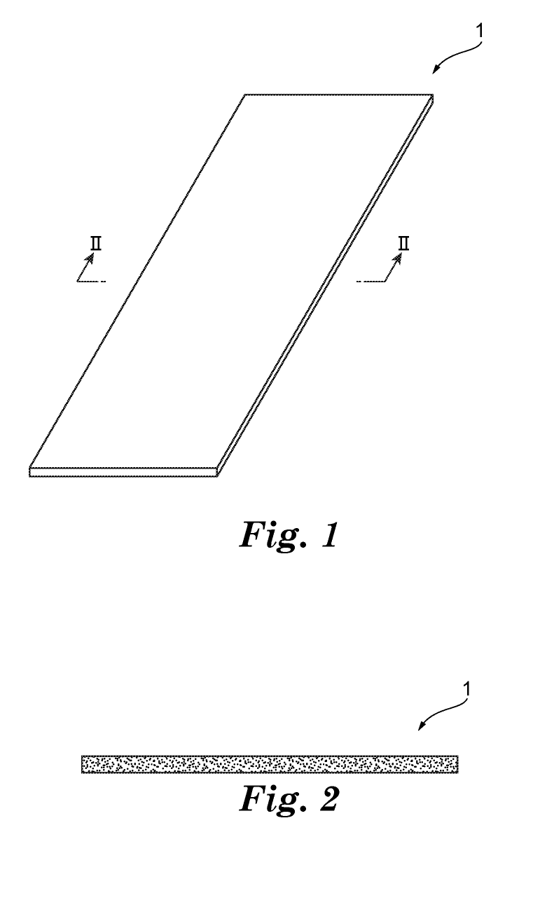

FIG. 1 is a perspective view illustrating an adhesive sheet according to an embodiment of the present invention. FIG. 2 is a drawing illustrating a cross-section taken along line II-II of FIG. 1. An adhesive sheet 1 is formed from an adhesive including an acrylic polymer, an epoxy resin, at least one type of thermoplastic resin selected from the group consisting of a phenoxy resin and a polyvinyl butyral resin, and an epoxy resin curing agent. The adhesive sheet 1 can also be configured such that the adhesive is molded into a sheet shape.

The amount of the epoxy resin in the adhesive is not less than 80 parts by mass, is preferably not less than 100 parts by mass, and is more preferably not less than 120 parts by mass per 100 parts by mass of the acrylic polymer. Additionally, the amount of the epoxy resin in the adhesive is not greater than 300 parts by mass, is preferably not greater than 200 parts by mass, and is more preferably not greater than 180 parts by mass per 100 parts by mass of the acrylic polymer.

The amount of the thermoplastic resin in the adhesive is not less than 15 parts by mass and is preferably not less than 20 parts by mass per 100 parts by mass of the acrylic polymer. Additionally, the amount of the thermoplastic resin in the adhesive may, for example, be 40 parts or less by mass and is preferably not greater than 35 parts by mass per 100 parts by mass of the acrylic polymer.

The various components included in the adhesive are described in detail below.

### Acrylic Polymer

The acrylic polymer is a polymer of monomer components including a (meth)acrylic acid ester having a homopolymer Tg of 80° C. or higher, a nitrogen-containing monomer, and a crosslinking monomer having an epoxy group.

An amount of the (meth)acrylic acid ester in the monomer components may, for example, be 20 mass % or greater or 30 mass % or greater, based on the entire mass of the monomer components. Additionally, the amount of the (meth)acrylic acid ester in the monomer components may, for example, be 60 mass % or less.

An amount of the nitrogen-containing monomer in the monomer components may, for example, be 20 mass % or greater, based on the entire mass of the monomer components. Additionally, the amount of the nitrogen-containing monomer in the monomer components may, for example, be 50 mass % or less.

An amount of the crosslinking monomer in the monomer components may, for example, be 2 mass % or greater, is preferably 5 mass % or greater, and is more preferably 10 mass % or greater, based on the entire mass of the monomer components. Additionally, the amount of the crosslinking monomer in the monomer components may, for example, be 30 mass % or less, is preferably 25 mass % or less, and is more preferably 20 mass % or less, based on the entire mass of the monomer components.

The monomer components may include monomers other than those described above. Amounts of the other monomers are not particularly limited, provided that the amounts are within a range where the effects of the present invention are not inhibited, and may, for example, be 10 mass % or less.

The acrylic polymer may also be a polymer having a structural unit derived from a monomer component. Additionally, the amount of each component in the monomer components can be expressed as the amount of the structural unit derived from each of the monomers in the acrylic polymer.

Each of the monomer components is described in detail below.

In the present embodiment, the homopolymer Tg of the (meth)acrylic acid ester is 80° C. or higher. Note that “the homopolymer Tg being 80° C. or higher” refers to the Tg of a homopolymer obtained by homopolymerizing (meth)acrylic acid ester being 80° C. or higher. The (meth)acrylic acid ester may be a monomer represented by Formula (1) below.

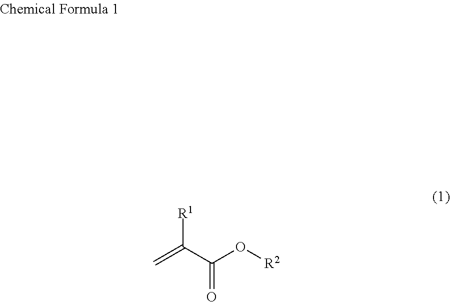

In Formula (1), R¹ is a hydrogen atom or methyl group, and R² is a hydrocarbon group. Provided that R² is a hydrocarbon group where the homopolymer Tg is 80° C. or higher, R² may be a chain, branched, or cyclic hydrocarbon group.

Examples of R² include dicyclopentenyl groups, dicyclopentanyl groups, isobornyl groups, and the like.

Specific examples of the (meth)acrylic acid ester include dicyclopentenyl acrylate (homopolymer Tg is 120° C.), dicyclopentanyl acrylate (homopolymer Tg is 120° C.), dicyclopentanyl methacrylate (homopolymer Tg is 175° C.), isobornyl acrylate (homopolymer Tg is 97° C.), and the like.

The nitrogen-containing monomer is a monomer that contains nitrogen atoms and is capable of copolymerizing with the (meth)acrylic acid ester and the crosslinking monomer to form the acrylic polymer.

The nitrogen-containing monomer may, for example, be a monomer having an ethylenically unsaturated double bond or may be a monomer having a (meth)acryloyl group.

Examples of the nitrogen-containing monomer include dialkyl(meth)acrylamides (e.g., dimethyl(meth)acrylamide, diethyl(meth)acrylamide), n-vinyl pyrrolidone, n-vinyl caprolactam, (meth)acryloyl morpholine, and the like.

The crosslinking monomer is a monomer that has an epoxy group and is capable of copolymerizing with the (meth)acrylic acid ester and the nitrogen-containing monomer to form the acrylic polymer.

The crosslinking monomer may, for example, be a monomer having an ethylenically unsaturated double bond or may be a monomer having a (meth)acryloyl group.

The crosslinking monomer may, for example, be a monomer having a glycidyl group.

Examples of the crosslinking monomer include glycidyl(meth)acrylate, 4-hydroxybutyl acrylate glycidyl ether, and the like.

The monomer components may further include a polyfunctional monomer having two or more ethylenically unsaturated double bonds. The polyfunctional monomer may be a monomer having two or more (meth)acryloyl groups.

Examples of the polyfunctional monomer include hexanediol di(meth)acrylate, nonanediol di(meth)acrylate, and the like.

The amount of the polyfunctional monomer in the monomer components may be appropriately adjusted in accordance with the use and the like of the adhesive. By compounding a large amount of the polyfunctional monomer, the fluidity of the acrylic polymer will decrease, leading to a tendency for the shape retention of the adhesive to be further improved; and by compounding a small amount of the polyfunctional monomer, the fluidity of the acrylic polymer will increase, leading to a tendency for the wettability, foaming, surface smoothness after curing, and the like of the adhesive to improve.

An amount of the polyfunctional monomer in the monomer components may, for example, be 0.01 mass % or greater, based on the entire mass of the monomer components. Additionally, the amount of the polyfunctional monomer in the monomer components may, for example, be 0.2 mass % or less, based on the entire mass of the monomer components.

The monomer components may further include monomers other than those described above. Examples of the other monomers include butyl acrylate, 2-ethylhexyl(meth)acrylate, isooctyl acrylate, lauryl(meth)acrylate, and the like. These monomers may be used, for example, for the purposes of adjusting the Tg of the acrylic polymer so as to improve the tackiness of the adhesive, adjusting the viscosity at a time of molding so as to improve the moldability, and the like. The amount of the other monomers may be appropriately adjusted in accordance with the use and the like of the adhesive and, for example, may be 10 mass % or less, based on the entire mass of the monomer components.

The form of polymerization of the monomer components is not particularly limited and may, for example, be random polymerization. That is, the acrylic polymer may be a random copolymer of the monomer components.

The polymerization reaction of the monomer components is not particularly limited, but is preferably radical polymerization. That is, the acrylic polymer is preferably a radical copolymer of the monomer components. The radical polymerization may, for example, be carried out by reacting the monomer components with a radical polymerization initiator.

The radical polymerization initiator is not particularly limited, provided that the radical polymerization of the monomer components can be initiated. For example, the radical polymerization initiator may be a photocurable radical polymerization initiator. Specific examples of the radical polymerization initiator include 2,2-dimethoxy-1,2-diphenylethane-1-one (Irgacure 651, manufactured by BASF), bis(2,4,6-trimethylbenzoyl)-phenyl phosphine oxide (Irgacure 819, manufactured by BASF), and the like. An amount of the radical polymerization initiator is not particularly limited and, for example, may be from 0.05 to 0.5 parts by mass or from 0.1 to 0.3 parts by mass per 100 parts by mass of the monomer components.

### Epoxy Resin

The epoxy resin is a component for curing the adhesive as a result of reacting with an epoxy resin curing agent. A compound having two or more epoxy groups can be beneficially used as the epoxy resin. Additionally, a compound including two or more epoxy resins and a compound including three or more epoxy resins may be used in combination as the epoxy resin. One type of epoxy resin may be used alone or two or more types of epoxy resin may be mixed and used.

Liquid epoxy resin can be beneficially used as the epoxy resin. Viscosity at 25° C. of the liquid epoxy resin may, for example, be 700 mPa·s or greater and 24000 mPa·s or less.

A compound having, for example, two or more glycidyl groups can be beneficially used as the epoxy resin. The epoxy resin may be a compound having two glycidyl groups.

Examples of the epoxy resin include bisphenol A type epoxy resins, bisphenol F type epoxy resins, phenol novolak type epoxy resins, cresol novolac epoxy resins, resorcinol type epoxy resins, phenol aralkyl type epoxy resins, and the like.

A commercially available product may be used as the epoxy resin. Examples of commercially available products of the epoxy resin include YD-128, YD-127, and YD-1285 (manufactured by Nippon Steel & Sumikin Chemical Co., Ltd.), YDF-170 (manufactured by Nippon Steel & Sumikin Chemical Co., Ltd.), jER-828 (manufactured by Mitsubishi Chemical Corporation), jER-806 (manufactured by Mitsubishi Chemical Corporation), EPICLON-840, EPICLON-850, and EPICLON-830 (manufactured by DIC Corporation), and the like.

### Thermoplastic Resin

The thermoplastic resin is selected from the group consisting of a phenoxy resin and a polyvinyl butyral resin. One type of thermoplastic resin may be used alone or two or more types of thermoplastic resin may be mixed and used.

As these thermoplastic resins, examples of commercially available products of the phenoxy resin include YP-50S, YP-50, YP-70, and FX-316 (manufactured by Nippon Steel & Sumikin Chemical Co., Ltd.), and the like; and examples of commercially available products of the polyvinyl butyral resin include Butvar B-79 and Butvar B-72 (manufactured by Eastman Chemical), and the like.

### Epoxy Resin Curing Agent

The epoxy resin curing agent is a component for curing the adhesive as a result of reacting with the epoxy resin. The epoxy resin curing agent can be appropriately selected from curing agents capable of curing epoxy resin, in accordance with the type, composition, and the like of the epoxy resin.

The epoxy resin curing agent may be a thermosetting or photocurable curing agent, and is preferably a thermosetting curing agent.

The epoxy resin curing agent may, for example, be a nitrogen-containing curing agent that contains nitrogen atoms and reacts with epoxy groups. Examples of such a curing agent include tetramethylguanidine, imidazole or a derivative thereof, carboxylic acid hydrazides, tertiary amines, aromatic amines, aliphatic amines, dicyandiamide or a derivative thereof, and the like.

Specific examples of the epoxy resin curing agent include dicyandiamide, 3-methyl-1,2,3,6-tetrahydrophthalic anhydride, 4-methyl-1,2,3,6-tetrahydrophthalic anhydride, diethylenetriamine, triethylenetetramine, and the like.

A commercially available product may be used as the epoxy resin curing agent. Examples of commercial products of, for example, dicyandiamides among epoxy resin curing agents include EH3636AS (manufactured by ADEKA), Dicyandiamide DD (manufactured by Nippon Carbide Industries Co., Inc.), DICY7 and DICY15 (manufactured by Mitsubishi Chemical Corporation), and the like.

An amount of the epoxy resin curing agent in the adhesive may be appropriately adjusted in a range whereby the epoxy resin can be cured, taking chemical equivalents into consideration. For example, in a cases where a dicyandiamide is used as the epoxy resin curing agent, the amount of the epoxy resin curing agent may be from 3 to 12 parts by mass per 100 parts by mass of the epoxy resin.

The adhesive may further include components other than those described above. The other components are described in detail below.

For example, the adhesive may further include a foaming agent. The foaming agent may be a component that produces foam as a result of heating. By compounding the foaming agent, the cured product of the adhesive can be made into a foam body. Additionally, as a result of the adhesive including the foaming agent, functions can be imparted to the adhesive sheet 1 such as improved shape deformation after curing due to the foam and improved adhesion to an adherend, density lowering, weight reduction, and the like.

A foaming agent that, when heating the adhesive, is foamable before the curing of the adhesive or simultaneous with the curing of the adhesive can be beneficially used as the foaming agent. By compounding this type of foaming agent, foam can be produced before the curing or during the curing of the adhesive.

A foaming starting temperature of the foam body is preferably lower than a curing starting temperature of the adhesive. As a result, foam can be produced in the adhesive that has fluidity, before curing. Additionally, a difference between the foaming starting temperature of the foaming agent and the curing starting temperature of the adhesive may, for example, be 5° C. or greater and is preferably 10° C. or greater. As a result, the foam body shape of the sufficiently foamed foaming agent will be maintained such that the adhesive can cure and a cured product of a desired shape can be obtained.

Note that in the present specification, the foaming starting temperature of the foaming agent refers to a temperature at which volumetric expansion exceeding normal thermal expansion occurs in the adhesive, and can be found through a typical thermomechanical analysis. Additionally, the curing starting temperature of the adhesive refers to a curing starting temperature measured using a differential scanning calorimeter (DSC measurement). Note that the curing starting temperature is a temperature at the inflection point of a curve (a DSC curve where heat quantity is on the vertical axis and temperature is on the horizontal axis) obtained through the DSC measurement.

An amount of the foaming agent in the adhesive may be appropriately adjusted in accordance with a desired foaming ratio, purpose of foaming (e.g. to increase the thickness, change the shape, or reduce the density of the adhesive sheet 1), or the like.

The type of foaming agent is not particularly limited. For example, the foaming agent may be an encapsulated type foaming agent constituted by a liquid hydrocarbon having a suitable boiling point being charged into a shell containing a thermoplastic resin. In cases where using an encapsulated type foaming agent, the shell expands upon heating of the foaming agent due to the liquid matter in the shell vaporizing. Examples of encapsulated type foaming agents include Matsumoto Microsphere® (manufactured by Matsumoto Yushi-Seiyaku Co., Ltd. (Osaka, Japan)), Expancel® (manufactured by Japan Fillite Co., Ltd. (Osaka, Japan)), Advancell (manufactured by Sekisui Chemical Co., Ltd.), and the like. An amount of the foaming agent is not particularly limited and may be adjusted in accordance with the purpose of the foaming. When the foaming agent is an encapsulated type, the amount of the foaming agent may, for example, be from 0.5 to 10 mass %, from 1 to 5 mass %, or from 1 to 2 mass %, based on the entire mass of the adhesive.

Additionally, the foaming agent may be a non-encapsulated type foaming agent that produces a gas such as nitrogen, nitrogen oxide, steam, carbon dioxide, or the like upon heating. Examples of non-encapsulated type foaming agents include azo-based foaming agents such as azobisisobutyronitrile, azodicarbonamide, and the like; carbazide-based foaming agents; hydrazide-based foaming agents; sodium borohydride; sodium bicarbonate; sodium citrate; dinitrosopentamethylene tetramine; and the like. An amount of the foaming agent is not particularly limited and may be adjusted in accordance with the purpose of the foaming. When the foaming agent is a non-encapsulated type, the amount of the foaming agent may, for example, be from 0.2 to 2 mass % or from 0.5 to 1.5 mass %, based on the entire mass of the adhesive.

The adhesive may further include a core-shell-type impact modifier. By compounding the core-shell-type impact modifier, the bonding strength at a time of curing the adhesive will tend to be greater.

The core-shell-type impact modifier may, for example, include a core having rubber elasticity and a shell that covers the core.

Resin material constituting the core is not particularly limited and may, for example, be a polybutadiene resin, a polystyrene resin, a butadiene-styrene copolymer resin, or the like. Resin material constituting the shell is not particularly limited and may, for example, be a polymethylmethacrylate resin, a silicone resin, or the like.

An amount of the core-shell-type impact modifier in the adhesive may be appropriately adjusted in accordance with the use of the adhesive sheet 1, the desired bonding strength, or the like. By adjusting the compounded amount of the core-shell-type impact modifier, it is expected that brittleness of the epoxy-cured product will improve and peel strength after curing will increase. Additionally, by adjusting the compounded amount of the core-shell-type impact modifier, it is expected that impact resistance at low temperatures will increase.

The amount of the core-shell-type impact modifier in the adhesive may, for example, be 5 mass % or greater or 10 mass % or greater, based on the entire mass of the adhesive. Additionally, the amount of the core-shell-type impact modifier in the adhesive may, for example, be 30 mass % or less or 20 mass % or less, based on the entire mass of the adhesive.

The adhesive may further include components other than those described above. Examples of these other components include curing aids, fillers, colorants, antioxidants, surfactants, tackifiers, plasticizers, and the like.

The curing aid is a component that promotes or suppresses the curing reaction of the epoxy resin by the epoxy resin curing agent. For example, it is known that the curing starting temperature can be controlled by adding a small amount of an imidazole compound as a curing aid to a system where a dicyandiamide is the main curing agent. By compounding an appropriate curing aid in the adhesive, the curing starting temperature of the adhesive, the curing reaction rate, and the like can be controlled, and cure characteristics matching the intended use can be set.

The curing aid may be appropriately selected in accordance with the type of epoxy resin curing agent, the desired curing temperature, and the like. In cases where the epoxy resin cured product is a dicyandiamide, the curing aid may, for example, be an imidazole compound, a tertiary amine compound, a phosphine compound, a urea compound, or the like. Examples of imidazole compounds that can be beneficially used include a variety of grades of the commercially available Curezol series from Shikoku Chemicals Corporation including, for example, Curezol 2MZA-PW (manufactured by Shikoku Chemicals Corporation), Curezol 2PHZ-PW (manufactured by Shikoku Chemicals Corporation), Curezol 2MA-OK (manufactured by Shikoku Chemicals Corporation), and the like. Examples of urea compounds include Omicure U-52 (manufactured by CVC Thermoset Specialities) and the like.

An amount of the curing aid in the adhesive can be appropriately adjusted in accordance with the type of curing aid, the desired curing temperature, and the like.

The filler may be compounded in the adhesive for the purpose of improving the moldability of the adhesive, adjusting the appearance, imparting characteristics such as flame retardance to the adhesive, reducing the weight of the adhesive, adjusting the bonding strength after curing, or the like.

Specific examples of the filler include inorganic fillers such as silica fillers (e.g. fumed silica), glass beads, alumina (aluminum oxide), aluminum hydroxide, and the like; organic fillers such as Hi-Pearl (manufactured by Negami Chemical Industrial Co., Ltd.), Matsumoto Microsphere (manufactured by Matsumoto Yushi Seiyaku Co., Ltd.), and the like; and the like.

The filler is preferably a filler that disperses excellently in the adhesive. For example, among silica fillers, a silica filler subjected to hydrophobic surface treatment can be beneficially used. Examples of such a silica filler include R972 (manufactured by Nippon Aerosil Co., Ltd.), Reolosil DM-10 (manufactured by Tokuyama Corporation), CAB-O-SIL TS-610 (manufactured by Cabot Corporation (USA)), and the like.

The adhesive may be colored by a colorant such as carbon black, various types of pigments, or the like. For example, by adjusting the color of the adhesive sheet 1 after curing so as to be similar to a color of an adherend, the bonded portion can be made less conspicuous and the attractiveness of the appearance can be improved.

Additionally, in the present embodiment, by appropriately selecting and adding a surfactant to the adhesive, the surface of the cured product of the adhesive sheet 1 can be smoothed and the appearance can be improved.

Additionally, in the present embodiment, by appropriately selecting and adding a tackifier to the adhesive, wettability and adhesion of the adhesive sheet 1 with respect to the adherend can be improved, and attaching workability can be improved.

Additionally, in the present embodiment, by adding an epoxy-based reaction diluent (e.g. the YED series, manufactured by Mitsubishi Chemical Corporation) to the adhesive, viscosity adjustment at a time of molding the sheet, reactivity of the curing reaction, adhesion after curing, and the like may be controlled.

The additives described above may be combined and added in a range whereby the required characteristics (bonding strength and the like) in accordance with the use are not impaired.

The method of manufacturing the adhesive is not particularly limited. For example, the adhesive can be obtained by preparing a liquid composition including the components described above and a solvent and, thereafter removing the solvent from the liquid composition.

Additionally, the adhesive can be obtained by photo irradiating an adhesive composition including the monomer components, the photocurable radical polymerization initiator, the epoxy resin, the thermoplastic resin, and the thermosetting epoxy resin curing agent. That is, the adhesive may be a photocured product of the adhesive composition described above.

In such an adhesive composition, due to the photocurable radical polymerization initiator being included, the monomer components can be polymerized and an acrylic polymer can be produced by photoirradiation. Additionally, in the adhesive composition due to the epoxy resin curing agent being thermosetting, the curing agent is not consumed by the photoirradiation. Therefore, the photocured product of the adhesive composition can be beneficially used as a thermosetting adhesive.

The adhesive sheet 1 will be described in detail below.

The adhesive sheet 1 is formed from the adhesive described above. The adhesive sheet 1 may, for example, be obtained by molding the adhesive. Additionally, the adhesive sheet 1 may be obtained by applying the liquid composition described above on a substrate such as PET film and, thereafter, removing the solvent. Additionally, the adhesive sheet 1 may be obtained by molding the adhesive composition described above into a sheet shape and, thereafter, subjecting the molded product to photocuring.

A thickness of the adhesive sheet 1 may be appropriately set in accordance with the use thereof. The thickness of the adhesive sheet 1 may, for example, be 0.01 mm or greater or 0.1 mm or greater. The thickness of the adhesive sheet 1 may, for example, be 3.0 mm or less or 1.0 mm or less.

The adhesive sheet 1 may be formed on a substrate such as PET film. The substrate may, for example, be PET film, PE film, PP film, or the like. The substrate may be disposed on one face of the adhesive sheet 1 or may be disposed on both faces of the adhesive sheet 1. The substrate is peeled at a time of use of the adhesive sheet 1. Therefore, the face of the substrate contacting the adhesive sheet 1 may be subjected to release treatment. By disposing the substrate on at least one face of the adhesive sheet 1, the adhesive sheet 1 can be transported and stored as a roll.

An airflow layer including an air-permeable material may be formed on at least one face of the adhesive sheet 1. That is, the adhesive sheet 1 may be constituted by an adhesive layer including the adhesive described above and the airflow layer provided on at least one face of the adhesive layer. Examples of the air-permeable material include fiber materials such as woven fabrics, meshes, knits, and non-woven fabrics. Examples of the fiber materials that can be used include fibrous materials having cotton, glass, polyester, polyimide, polypropylene, carbide, aramid, metal, or a combination thereof as a material. A porous layer can be formed in these air-permeable materials and this layer can function as an airflow layer capable of passing air there-through.

When bonding the adhesive sheet 1 to an adherend, in some cases moisture (or other volatile matter) adhering to the adherend evaporates due to the heating when curing, resulting in the production of steam. Here, if there is no escape route for the steam, air bubbles may be produced in the end portion of the adhesive sheet 1 due to the steam passing through the adhesive sheet 1, and the appearance of the formed bonded members may be negatively affected. As a countermeasure, due to the airflow layer being present between the adhesive sheet 1 and the adherend in the present embodiment, the steam passes through the airflow layer and, as a result, the production of air bubbles in the end portion of the adhesive sheet 1 is suppressed. After the steam passes, sufficient bonding strength is ensured due to the adhesive, which has been fluidized due to the heating, filling the gaps in the airflow layer and coming into contact with the adherend. These behaviors can be realized by controlling the fluidity before curing and the curing starting temperature of the adhesive.

Note that in cases where comparatively stiff woven fabric, mesh, knit, or the like is used as the air-permeable material, the sheet shape before curing can be maintained and a function of making handling easier can be expected.

Next, a metal member assembly and a method for manufacturing the same according to an embodiment of the present invention will be described in detail. Note that in the following, an embodiment of the metal member assembly that is beneficially used in automobile parts or the like is described, but in the present invention, the use of the adhesive sheet 1 is not limited thereto. For example, the adhesive sheet 1 can be used as a structural adhesive film to bond members of the same type among members such as metal members, glass members, and resin members, and can also be used to bond members of differing types.

The metal member assembly according to the present embodiment includes a first metal member; a second metal member; and a bonding member containing a cured product of the adhesive described above. In this metal member assembly, at least a portion of the bonding member is disposed between the first metal member and the second metal member. The bonding member may be a cured product of the adhesive sheet 1.

With the metal member assembly configured thusly, due to the fact that the bonding member includes the cured product of the adhesive described above, the bonding strength between the first metal member and the second metal member is high and mechanical strength is superior. Note that the bonding strength between the first metal member and the second metal member is not particularly limited, provided that the required characteristics in accordance with the use or the like of the metal member assembly are satisfied.

Provided that the first metal member and the second metal member are bonded via the bonding member, other structures of the metal member assembly are not particularly limited. For example, the first metal member and the second metal member of the metal member assembly may form a hem flange structure. Specifically, for example, an end portion of the first metal member may be pressed so as to sandwich the second metal member.

Use of the metal member assembly is not particularly limited and, for example, can be beneficially used in uses such as automobile parts, automobile/aircraft structural members, building structural members, and industrial equipment parts.

A method for manufacturing the metal member assembly according to the present embodiment includes a first step of forming a metal adhered body by disposing the adhesive described above between at least a portion of a first metal member and a second metal member; and a second step of obtaining a metal member assembly in which the first metal member and the second metal member are bonded to each other by heating the metal adhered body so as to cure the adhesive.

In such a manufacturing method, the first metal member and the second metal member are bonded by the adhesive described above and, therefore, the bonding strength between the first metal member and the second metal member is high and a metal member assembly with superior mechanical strength can be obtained.

In one aspect, the adhesive disposed between the first metal member and the second metal member may be the adhesive sheet 1. In this case, due to the fact that the adhesive sheet 1 has superior shape retention, necessary adhesion area at necessary positions can be reliably ensured and the protrusion of the adhesive onto unnecessary locations can easily be prevented.

In the first step, for example, the adhesive may be disposed on one of the metal members and, thereafter, the other metal member may be disposed on the adhesive. Additionally, the metal adhered body may be formed by pressure bonding the first metal member and the second metal member with the adhesive sheet 1 interposed therebetween.

In the first step, two of more of the adhesives may be disposed between the first metal member and the second metal member. The composition and shape of each of the two or more adhesives may be identical or may differ. For example, in the first step, the adhesive sheet 1 and an adhesive sheet constituted from an adhesive of a composition differing from that of the adhesive sheet 1 may be disposed between the first metal member and the second metal member. Additionally, in the first step, two of more of the adhesive sheets 1 may be disposed between the first metal member and the second metal member.

In the second step, the heating temperature, temperature raising rate, and the like may be appropriately adjusted in accordance with the curing temperature of the adhesive. Additionally, in cases where the adhesive includes the foaming agent, the heating temperature, temperature raising rate, and the like may be adjusted while considering the foaming starting temperature.

The manufacturing method according to the present embodiment can be beneficially used in, for example, the formation of a hem flange structure. Hem flange structures are structures in which an outer steel plate and an inner steel plate are bonded by pressing the end portion of the outer steel plate so as to sandwich the inner steel plate. In the present embodiment, a hem flange structure can be formed in which the adhesive is disposed between the outer steel plate and the inner steel plate.

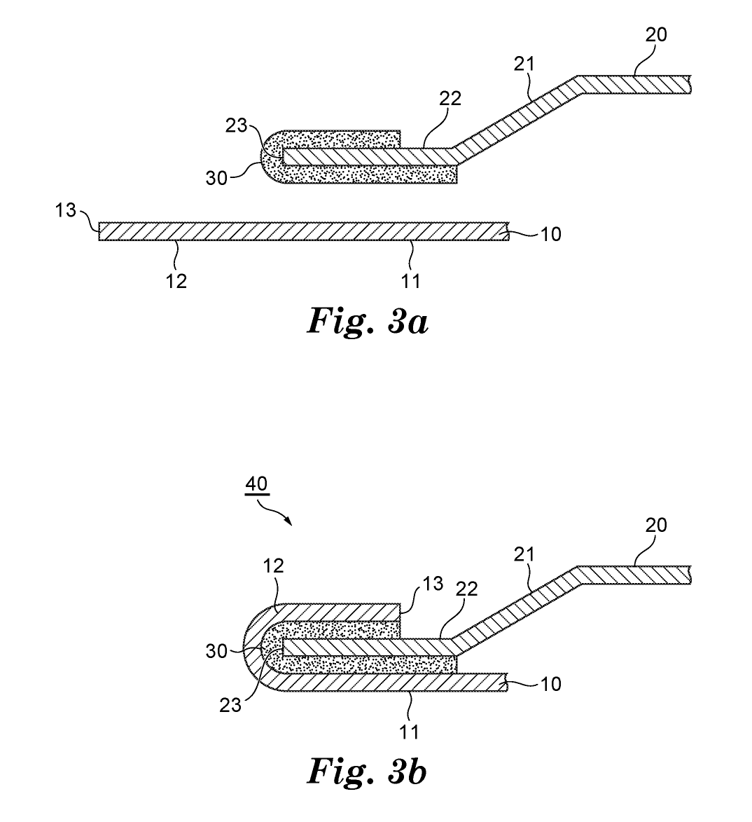

FIGS. 3A and 3B are drawings for explaining an aspect of the method for manufacturing a metal member assembly. In the manufacturing method illustrated in FIGS. 3A and 3B, an outer steel plate 10 and an inner steel plate 20 are bonded using an adhesive sheet 30. The outer steel plate 10 has a main body portion 11 and a bend portion 12 extending from the main body portion 11 to an end portion 13 side of the outer steel plate 10. Additionally, the inner steel plate 20 has a main body portion 21 and a sandwiched portion 22 extending from the main body portion 21 to an end portion 23 side of the inner steel plate 20.

The manufacturing method illustrated in FIGS. 3A and 3B includes a preparation step in which the outer steel plate 10 and the inner steel plate 20 with the adhesive sheet 30 adhered thereto are prepared; a bending step in which a metal adhered body 40 is formed by folding back the bend portion 12 of the outer steel plate 10 so as to sandwich the sandwiched portion 22 of the inner steel plate 20; and a heating step in which the metal member assembly is obtained by heating the metal adhered body 40 so as to cure the adhesive sheet 30. Note that the preparation step and the bending step correspond to the first step described above and the heating step corresponds to the second step described above.

As illustrated in FIG. 3A, the outer steel plate 10 and the inner steel plate 20 with the adhesive sheet 30 adhered to the sandwiched portion 22 are prepared in the preparation step. The adhesive sheet 30 is adhered to a range of the sandwiched portion 22 of the inner steel plate 20 that will be sandwiched by the outer steel plate 10. Additionally, the adhesive sheet 30 is adhered to the inner steel plate 20 so as to cover the end portion 23 of inner steel plate 20 from one face of the sandwiched portion 22 to the other face.

As illustrated in FIG. 3B, in the bending step, the metal adhered body 40 is formed by folding back the bend portion 12 of the outer steel plate 10 so as to sandwich the sandwiched portion 22 of the inner steel plate 20. Here, the outer steel plate 10 may be folded back so that the end portion 13 of the outer steel plate 10 is flush with the end portion of the adhesive sheet 30.

In the heating step, the metal adhered body 40 is heated so as to cure the adhesive sheet 30 and a metal member assembly having a hem flange structure (not illustrated) is obtained. The heating method is not particularly limited, provided that the method is capable of curing the adhesive sheet 30. For example, the adhesive sheet 30 may be heated by heating the outer steel plate 10 or the inner steel plate 20, or the adhesive sheet 30 may be heated by holding the metal adhered body in a high-temperature environment.

The metal member assembly formed from the metal adhered body 40 is an assembly that includes the outer steel plate 10, the inner steel plate 20, and a bonding member formed from a cured product of an adhesive sheet 50 disposed between the outer steel plate 10 and the inner steel plate 20.

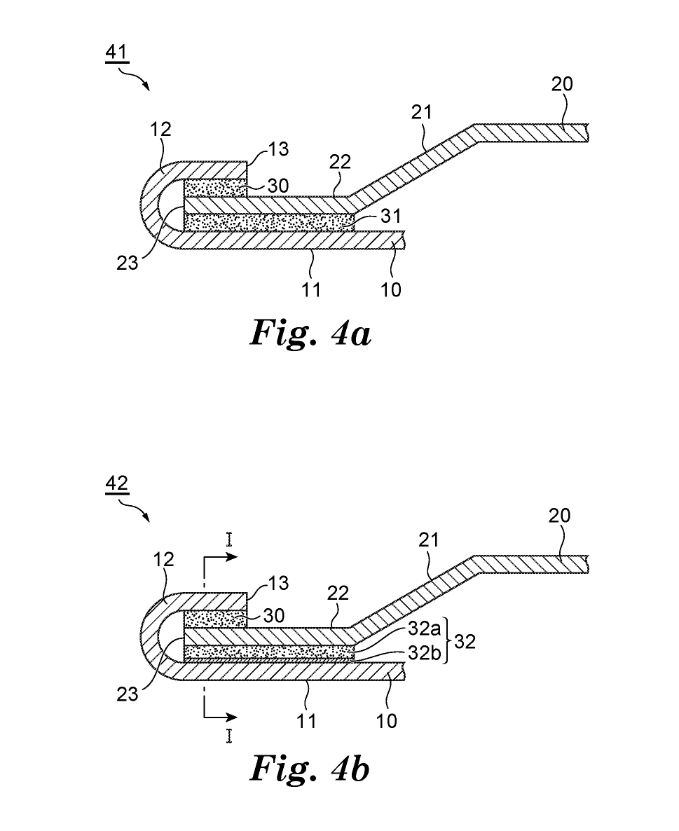

FIG. 4A is a drawing for explaining another aspect of the method for manufacturing a metal member assembly.

In the aspect illustrated in FIG. 4A, the outer steel plate 10 and the inner steel plate 20 are bonded using two adhesive sheets 30 and 31. Of the adhesive sheets 30 and 31, at least one is constituted by the adhesive according to the present embodiment, and the other may be constituted by the adhesive according to the present embodiment or may be constituted by another adhesive.

In the aspect illustrated in FIG. 4A, the method for manufacturing a metal member assembly includes a preparation step in which the outer steel plate 10 and the inner steel plate 20 with the adhesive sheet 30 and the adhesive sheet 31 adhered thereto are prepared; a bending step in which a metal adhered body 41 is formed by folding back the bend portion 12 of the outer steel plate 10 so as to sandwich the sandwiched portion 22 of the inner steel plate 20; and a heating step in which the metal member assembly is obtained by heating the metal adhered body 41 so as to cure the adhesive sheet 30 and the adhesive sheet 31. Note that the preparation step and the bending step correspond to the first step described above and the heating step corresponds to the second step described above.

In the preparation step, the adhesive sheet 30 is adhered on a first main surface of the sandwiched portion 22 of the inner steel plate 20, and the adhesive sheet 31 is adhered on a second main surface of the sandwiched portion 22. The adhesive sheet 30 and the adhesive sheet 31 are adhered to a range of the sandwiched portion 22 of the inner steel plate 20 that will be sandwiched by the outer steel plate 10.

In the bending step, the metal adhered body 41 is formed by folding back the bend portion 12 of the outer steel plate 10 so as to sandwich the sandwiched portion 22 of the inner steel plate 20. Here, a gap may exist between the end portion 23 of the inner steel plate 20 and the outer steel plate 10.

In the heating step, the metal adhered body 41 is heated so as to cure the adhesive sheet 30 and the adhesive sheet 31, and a metal member assembly having a hem flange structure (not illustrated) is obtained. The heating method is not particularly limited, provided that the method is capable of curing both the adhesive sheet 30 and the adhesive sheet 31. For example, the adhesive sheet 30 and the adhesive sheet 31 may be heated by heating the outer steel plate 10 or the inner steel plate 20, or the adhesive sheet 30 and the adhesive sheet 31 may be heated by holding the metal adhered body in a high-temperature environment.

The metal member assembly formed from the metal adhered body 41 includes the outer steel plate 10, the inner steel plate 20, a first bonding member that bonds the first main surface of the inner steel plate 20 and the end portion 13 side of the outer steel plate 10, and a second bonding member that bonds the second main surface of the inner steel plate 20 and the main body portion 11 of the outer steel plate 10. The first bonding member may include a cured product of the adhesive constituting the adhesive sheet 30, and the second bonding member may include a cured product of the adhesive constituting the adhesive sheet 31.

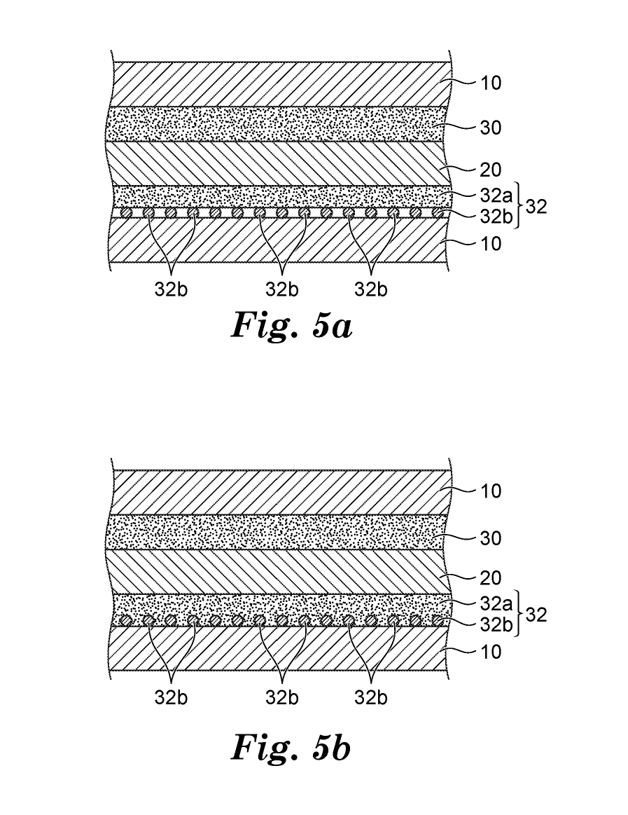

FIG. 4B is a drawing for explaining yet another aspect of the method for manufacturing a metal member assembly. FIG. 5A is an exploded view of a cross-section taken along line I-I of FIG. 4B. FIG. 5B is an exploded view of the same cross-section in a metal member assembly.

In the aspect illustrated in FIG. 4B, the outer steel plate 10 and the inner steel plate 20 are bonded using the adhesive sheet 30 and an adhesive sheet 32 having an adhesive layer 32a and an airflow layer 32b including an air-permeable material. Of the adhesive constituting the adhesive sheet 30 and the adhesive constituting the adhesive layer 32a, at least one is the adhesive according to the present embodiment, and the other may be the adhesive according to the present embodiment or may be another adhesive.

In the aspect illustrated in FIG. 4B, the method for manufacturing a metal member assembly includes a preparation step in which the outer steel plate 10 and the inner steel plate 20 with the adhesive sheet 30 and the adhesive sheet 32 adhered thereto are prepared; a bending step in which a metal adhered body 42 is formed by folding back the bend portion 12 of the outer steel plate 10 so as to sandwich the sandwiched portion 22 of the inner steel plate 20; and a heating step in which the metal member assembly is obtained by heating the metal adhered body 42 so as to cure the adhesive sheet 30 and the adhesive sheet 32. Note that the preparation step and the bending step correspond to the first step described above and the heating step corresponds to the second step described above.

In the preparation step, the adhesive sheet 30 is adhered on a first main surface of the sandwiched portion 22 of the inner steel plate 20, and the adhesive sheet 32 is adhered on a second main surface of the sandwiched portion 22. The adhesive sheet 30 and the adhesive sheet 32 are adhered to a range of the sandwiched portion 22 of the inner steel plate 20 that will be sandwiched by the outer steel plate 10. In this aspect, of the main surfaces of the inner steel plate 20, the adhesive sheet 30 is adhered on the main surface of the side facing the bend portion 12 of the outer steel plate 10; and, of the main surfaces of the inner steel plate 20, the adhesive sheet 32 is adhered on the main surface of the side facing the main body portion 11 of the outer steel plate 10.

In the bending step, the metal adhered body 42 is formed by folding back the bend portion 12 of the outer steel plate 10 so as to sandwich the sandwiched portion 22 of the inner steel plate 20. Here, a gap may exist between the end portion 23 of the inner steel plate 20 and the outer steel plate 10.

In the heating step, the metal adhered body 42 is heated so as to cure the adhesive sheet 30 and the adhesive sheet 32, and a metal member assembly having a hem flange structure (not illustrated) is obtained. The heating method is not particularly limited, provided that the method is capable of curing both the adhesive sheet 30 and the adhesive sheet 32. For example, the adhesive sheet 30 and the adhesive sheet 32 may be heated by heating the outer steel plate 10 or the inner steel plate 20, or the adhesive sheet 30 and the adhesive sheet 32 may be heated by holding the metal adhered body in a high-temperature environment.

In the hem flange structure, the gap between the end portion 23 of the inner steel plate 20 and the outer steel plate 10 may be sealed. If volatile matter such as water is present within this sealed gap, when the volatile matter volatilizes and expands in the heating step, the volatile matter may pass through the adhesive sheet for which viscosity has been lowered due to the heating. In such a case, air bubbles may be produced in the end portion of the adhesive sheet and the appearance of the formed bonding member may be negatively affected. As a countermeasure, in this aspect, the airflow layer 32b is present between the adhesive layer 32a and the outer steel plate 10 and, therefore, the volatilized and expanded volatile matter within the gap passes through the airflow layer 32b. As a result, in this aspect, the production of air bubbles in the end portions of the adhesive sheet 30 and the adhesive layer 32a is suppressed. After the volatile matter passes, sufficient bonding strength is ensured due to the adhesive layer 32a, which has been fluidized due to the heating, filling the gaps in the airflow layer 32b and coming into contact with the outer steel plate 10 (FIG. 5B).

The metal member assembly formed from the metal adhered body 42 is an assembly that includes the inner steel plate 20, a first bonding member that bonds the first main surface of the inner steel plate 20 and the end portion 13 side of the outer steel plate 10, and a second bonding member that bonds the second main surface of the inner steel plate 20 and the main body portion 11 of the outer steel plate 10. The first bonding member may include a cured product of the adhesive constituting the adhesive sheet 30. Additionally, the second bonding member may include a cured product of the adhesive constituting the adhesive layer 32a of the adhesive sheet 31, and the air-permeable material embedded in the cured product.

While an example has been described in which the adhesive sheet is used to bond steel plates in a hem flange structure, the adherend is not limited to steel plates and may be a metal material such as aluminum, a resin material, or the like. Additionally, there are no limitations on the type of adherend and the type of member, and the adhesive sheet may also be used in cases where differing adherends are bonded, such as a metal material and a resin material or the like.

A preferred embodiment of the present invention is described above, but the present invention is not limited to the abovementioned embodiment.

### EXAMPLES

The present invention is described more specifically below using working examples, but the present invention is not limited to the working examples.

### Working Examples 1 to 16

Adhesive compositions were prepared by compounding the components at the amounts shown in Tables 1 or Table 2.

Each of the adhesive compositions was molded into a sheet shape, such that a thickness thereof is 0.4 mm, between PET films that have been subjected to light peeling treatment. The molded sheets were subjected to irradiation of ultraviolet light at 1 mW from a light source using an ultraviolet fluorescent lamp (VC7692 T12 bulb, manufactured by Sylvania Corp.) for three minutes, and thereafter were subjected to irradiation at 5 mW for three minutes. The monomer components copolymerized due to the ultraviolet light and sheet shape adhesives (adhesive sheets) were obtained.

The obtained adhesive sheets were evaluated by the following methods for shape retention, T-peel strength at room temperature and at 80° C., and shear strength at room temperature and at 80° C. The results obtained are shown in Table 1 and Table 2.

### Evaluation of Shape Retention

Samples having a length of 100 mm and a width of 25 mm were cut from each of the adhesive sheets. The samples were allowed to sit at rest for 24 hours and, after the 24 hours, whether or not the sheet shape was maintained was visually confirmed. Cases where the shape of the sample was maintained were given an “A” evaluation and cases where the corners of the edges of the samples had deformed were given a “B” evaluation.

### Measurement of T-Peel Strength

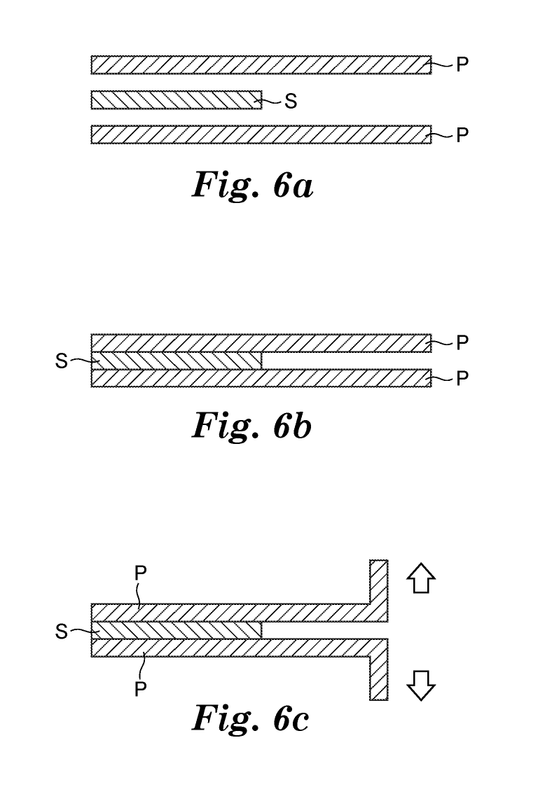

FIGS. 6A to 6C are drawings for explaining the evaluation method of T-peel strength in the examples. First, two steel plates P having a length of 150 mm, a width of 25 mm, and a thickness of 0.8 mm, and samples S cut from each of the adhesive sheets having a length of 120 mm and a width of 25 mm were prepared (FIG. 6A). The sample S was adhered to one of the steel plates P and, thereafter, the other steel plate P was overlapped on the steel plate P with the sample S and the two steel plates P were crimped and fixed using a clip. While fixed by the clip, the plates P together with the sample S were placed in a 170° C. oven for 30 minutes so as to cure the sample S. Thus, a test structure was obtained (FIG. 6B). Note that in cases where the sample S protruded from between the steel plates P, the protruding portion was cut off after the curing. Next, end portions of the steel plates P not sandwiching the sample S were folded outward 90 degrees and, using the folded portions as gripping tabs, the steel plates P were pulled at a rate of 200 mm/min so as to separate in a direction perpendicular to a surface direction of the plates P (FIG. 6C). Tensile strength during the splitting was measured and an average value thereof was recorded as the T-peel strength (N/25 mm).

Note that measured results under conditions of about 23° C. and about 50% RH were recorded as the T-peel strength at room temperature and results where the sample was heated to 80° C. and the tests were conducted within a chamber set to the same temperature were recorded as the T-peel strength at 80° C.

### Measurement of Shear Strength

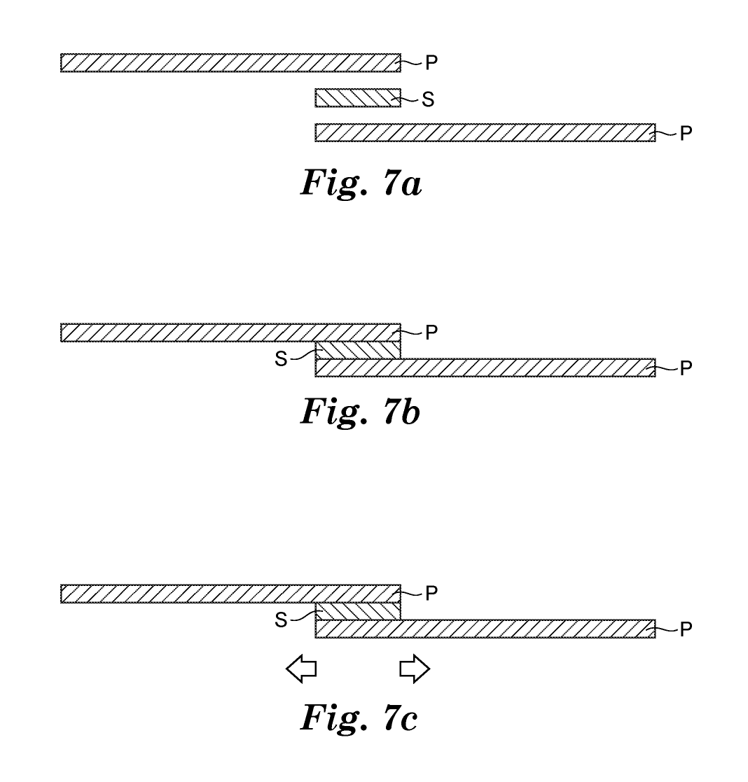

FIGS. 7A to 7C are drawings for explaining the evaluation method of shear strength in the examples. First, two steel plates P having a length of 100 mm, a width of 10 mm, and a thickness of 1.6 mm, and samples S cut from each of the adhesive sheets having a length of 10 mm and a width of 10 mm were prepared (FIG. 7A). The sample S was adhered to an end portion of one of the steel plates and, thereafter, the other steel plate P was adhered to the steel plate P with the sample S such that the sample S was disposed at the end portion of the other steel plate P and the steel plates P only overlapped each other at the portion where the sample S was disposed. The portion where the steel plates P overlapped was gripped and fixed using a clip, and the plates P together with the sample S were placed in a 170° C. oven for 30 minutes so as to cure the sample S. Thus, a test structure was obtained (FIG. 7B). Note that in cases where the sample S protruded from between the steel plates P, the protruding portion was cut off after the curing. Next, using the portions of the steel plates P where the sample S was not disposed as gripping tabs, the steel plates P were pulled at a rate of 5 mm/min so as to separate in the surface direction of the plates P (FIG. 7C). Strength at the time of breakage was measured and the shear strength (MPa) was calculated from this measured value and the adhesion area.

Note that measured results under conditions of about 23° C. and about 50% RH were recorded as the shear strength at room temperature and results where the sample was heated to 80° C. and the tests were conducted within a chamber set to the same temperature were recorded as the shear strength at 80° C.

TABLE 1

| | | Working | Working | Working | Working | Working | Working | Working | Working |
|---|---|---|---|---|---|---|---|---|---|
| | | Example 1 | Example 2 | Example 3 | Example 4 | Example 5 | Example 6 | Example 7 | Example 8 |
| Monomer | DMMA | 20 | 20 | 20 | 20 | 20 | 20 | 20 | 20 |
| components | FA-511AS | 20 | 20 | 20 | 20 | 20 | 20 | 20 | 20 |
| | BA | 2 | 2 | — | — | 2 | — | 2 | — |
| | 2EHA | 2 | 2 | 4 | 4 | 2 | 4 | 2 | 4 |
| | GMA | 8 | 8 | 8 | 8 | 8 | 6 | 8 | 6 |
| | HD-N | — | — | — | — | — | — | — | — |
| Photoinitiator | Irg651 | 0.6 | 0.6 | 0.6 | 0.6 | 0.6 | 0.6 | 0.6 | 0.6 |
| Phenoxy resin | YP-50S | 16 | 16 | 16 | 16 | 16 | 16 | 16 | 16 |
| Epoxy resin | YD-128 | 20 | — | 20 | — | 20 | 10 | — | 10 |
| | YDF-170 | 54.4 | 74.4 | 54.4 | 74.4 | 54.4 | 61.2 | 74.4 | 61.2 |
| Impact modifier | BTA731 | 25.6 | 25.6 | 25.6 | 25.6 | 25.6 | 28.8 | 25.6 | 28.8 |
| Thermosetting agent | DICY | 5.6 | 5.6 | 5.6 | 5.6 | 5.6 | 5.6 | 5.6 | 5.6 |
| Curing aid | 2MZA-PW | 0.5 | 0.5 | 0.5 | 0.5 | — | — | 0.5 | — |
| | 2PHZ-PW | — | — | — | — | 1 | 1 | — | 1 |
| Foaming agent | FN-100SD | — | — | — | — | 2 | 2 | — | — |
| | FN-100MD | — | — | — | — | — | — | — | — |
| | FN-80GSD | — | — | — | 3 | 0.5 | 0.5 | — | — |
| Filler | R-972 | — | — | — | — | — | — | 2 | 2 |
| Total weight of monomer | | 52 | 52 | 52 | 52 | 52 | 50 | 52 | 50 |
| components (A) | | | | | | | | | |
| Total weight of epoxy resin | | 74.4 | 74.4 | 74.4 | 74.4 | 74.4 | 71.2 | 74.4 | 71.2 |
| (B) | | | | | | | | | |
| Total weight of | | 16 | 16 | 16 | 16 | 16 | 16 | 16 | 16 |
| thermoplastic resin (C) | | | | | | | | | |
| B/A × 100 | | 143 | 143 | 143 | 143 | 143 | 142 | 143 | 142 |
| C/A × 100 | | 31 | 31 | 31 | 31 | 31 | 32 | 31 | 32 |
| Shape retention | | A | A | A | A | A | A | A | A |
| T-peel strength | Room | 180 | 160 | 180 | 180 | 85 | 140 | 220 | 170 |
| | temperature | | | | | | | | |
| | 80° C. | 180 | 155 | 180 | 190 | 80 | 160 | 210 | 300 |
| Shear strength | Room | 29 | 27.3 | 27.9 | 21 | 26.7 | 27.7 | 39.8 | 39.5 |
| | temperature | | | | | | | | |
| | 80° C. | 28.2 | 26.5 | 27.1 | 12 | 20.8 | 17 | 28.1 | 28.5 |

TABLE 2

| | | | Working | Working | Working | Working | Working | Working | Working |
|---|---|---|---|---|---|---|---|---|---|
| | | Working | Example | Example | Example | Example | Example | Example | Example |
| | | Example 9 | 10 | 11 | 12 | 13 | 14 | 15 | 16 |
| Monomer | DMMA | 20 | 20 | 20 | 20 | 15 | 20 | 20 | 20 |
| components | FA-511AS | 20 | 20 | 20 | 20 | 20 | 20 | 20 | 20 |
| | BA | — | — | 2 | — | — | 2 | 2 | 2 |
| | 2EHA | 4 | 4 | 2 | 4 | 4 | — | — | — |
| | GMA | 10 | 6 | 6 | 6 | 6 | 8 | 8 | 8 |
| | HD-N | — | — | — | — | — | — | — | 0.14 |
| Photoinitiator | Irg651 | 0.6 | 0.6 | 0.6 | 0.6 | 0.6 | 0.6 | 0.6 | 0.6 |
| Phenoxy resin | YP-50S | 16 | 10 | 10 | 16 | 15 | 16 | 16 | 16 |
| Epoxy resin | YD-128 | 10 | — | 20 | 30 | | 20 | 10 | 20 |
| | YDF-170 | 61.2 | 70.04 | 68 | 47.6 | 94.4 | 54.4 | 61.2 | 54.4 |
| Impact modifier | BTA731 | 28.8 | 32.96 | 32 | 22.4 | 25.6 | 25.6 | 28.8 | 25.6 |
| Thermosetting agent | DICY | 5.6 | 5.6 | 6.86 | 5.6 | 6.9 | 5.6 | 5.6 | 5.6 |
| Curing aid | 2MZA-PW | 0.5 | 0.5 | 0.61 | 0.5 | — | 0.5 | 0.5 | — |
| | 2PHZ-PW | — | — | — | — | 1 | — | — | 1 |
| Foaming agent | FN-100SD | — | — | — | — | — | — | — | 2 |
| | FN-100MD | — | — | — | — | — | — | 2 | — |
| | FN-80GSD | — | — | — | — | 1 | 3 | — | — |
| Filler | R-972 | 2 | 2 | 2 | 2 | 2 | — | — | — |
| Total weight of monomer | | 54 | 50 | 50 | 50 | 45 | 50 | 50 | 50.14 |
| components (A) | | | | | | | | | |
| Total weight of epoxy resin (B) | | 71.2 | 70.04 | 88 | 77.6 | 94.4 | 74.4 | 71.2 | 74.4 |
| Total weight of thermoplastic | | 16 | 10 | 10 | 16 | 15 | 16 | 16 | 16 |
| resin (C) | | | | | | | | | |
| B/A × 100 | | 132 | 140 | 176 | 155 | 210 | 149 | 142 | 148 |
| C/A × 100 | | 30 | 20 | 20 | 32 | 33 | 32 | 32 | 32 |
| Shape retention | | A | A | A | A | A | A | A | A |
| T-peel strength | Room | 120 | 105 | 155 | 90 | 210 | 85 | 85 | 120 |
| | temperature | | | | | | | | |
| | 80° C. | 200 | 900 | 140 | 70 | 210 | 110 | 81 | 110 |
| Shear strength | Room | 41.1 | 39.9 | 38.1 | 41.2 | 19.1 | 24.4 | 27.2 | 24.6 |
| | temperature | | | | | | | | |
| | 80° C. | 26.9 | 25.1 | 29.6 | 30.2 | 14.7 | 15.9 | 14.1 | 20.1 |

Note that Table 1 and Table 2 show the amounts of the components in terms of mass ratios. In Tables 1 and 2, “DMAA” is dimethyl acrylamide, “FA-511AS” is dicyclopentenyl acrylate, “BA” is n-butyl acrylate, “2EHA” is 2-ethylhexyl acrylate, and “GMA” is glycidyl methacrylate. “HD-N” is 1,6-hexane diol dimethacrylate. “Irg651” is a photocurable radical polymerization initiator, and specifically is “Irugacure 651”, manufactured by BASF. “YP-50S” is a phenoxy resin, and specifically is “YP-50S”, manufactured by Nippon Steel & Sumikin Chemical Co., Ltd. “YD-128” is a bisphenol A type epoxy resin, and specifically is “YD-128”, manufactured by Nippon Steel & Sumikin Chemical Co., Ltd. “YDF-170” is a bisphenol F type epoxy resin, and specifically is “YDF-170”, manufactured by Nippon Steel & Sumikin Chemical Co., Ltd. “BTA731” is a core-shell-type impact modifier, and specifically is “BTA731”, manufactured by Rohm & Hass Co. “DICY” is a thermosetting epoxy resin curing agent, namely a dicyandiamide, and specifically is “EH3636AS”, manufactured by ADEKA Corporation. “2MZA-PW” is a curing aid, and specifically is “2MZA-PW”, manufactured by Shikoku Chemicals Corporation. “2PHZ-PW” is a curing aid, and specifically is “2PHZ-PW”, manufactured by Shikoku Chemicals Corporation. “R972” is a hydrophobic surface-treated silica, and specifically is “R-972”, manufactured by Nippon Aerosil Co., Ltd. “FN-100SD” is a foaming agent, and specifically is “FN-100SD”, manufactured by Matsumoto Yushi Seiyaku Co., Ltd. “FN-100MD” is a foaming agent, and specifically is “FM-100SD”, manufactured by Matsumoto Yushi Seiyaku Co., Ltd. “FN-80GSD” is a foaming agent, and specifically is “FN-80GSD”, manufactured by Matsumoto Yushi Seiyaku Co., Ltd.

### Comparative Example 1

An adhesive sheet was obtained in the same way as for Working Example 1, except that the formulation of the adhesive composition was changed to that shown in Table 3. Additionally, as with Working Example 1, the obtained adhesive sheet was evaluated for shape retention, T-peel strength at room temperature and at 80° C., and shear strength at room temperature and at 80° C. The obtained results are shown in Table 3.

TABLE 3

| | | Comparative |
|---|---|---|
| | | Example 1 |
| Monomer components | DMMA | 20 |
| | FA-511AS | 20 |
| | BA | — |
| | 2EHA | 4 |
| | GMA | 6 |
| Photoinitiator | Irg651 | 0.6 |
| Phenoxy resin | YP-50S | 5 |
| Epoxy resin | YD-128 | — |
| | YDF-170 | 68 |
| Impact modifier | BTA731 | 32 |
| Thermosetting agent | DICY | 5.6 |
| Curing aid | 2MZA-PW | 0.5 |
| | 2PHZ-PW | — |
| Foaming agent | FN-100SD | — |
| | FN-80GSD | — |
| Filler | R-972 | 2 |
| Total weight of monomer | | 50 |
| components (A) | | |
| Total weight of epoxy resin (B) | | 68 |
| Total weight of thermoplastic resin | | 5 |
| (C) | | |
| B/A × 100 | | 136 |
| C/A × 100 | | 10 |
| Shape retention | | B |
| T-peel strength | Room temperature | 120 |
| | 80° C. | 115 |
| Shear strength | Room temperature | 31.8 |
| | 80° C. | 24.8 |

### Working Examples 17 to 19

Adhesive sheets were obtained in the same way as for Working Example 1, except that the formulations of the adhesive compositions were changed to those shown in Table 4. Additionally, as with Working Example 1, the obtained adhesive sheets were evaluated for shape retention, T-peel strength at room temperature and at 80° C., and shear strength at room temperature and at 80° C. Moreover, an expansion rate by the foaming was measured by the following method. The results are shown in Table 4.

### Evaluation of Expansion Rate

A steel plate having a length of 75 mm, a width of 50 mm, and a thickness of 0.8 mm, and samples cut from each of the sheet shape adhesives having a length of 50 mm and a width of 25 mm were prepared. The sample was placed on the steel plate and heated at 170° C. for 30 minutes. Thickness after the heating was measured and the amount of change from the thickness before the heating was recorded as the expansion rate (%).

TABLE 4

| | | Working | Working | Working |
|---|---|---|---|---|
| | | Example 17 | Example 18 | Example 19 |
| Monomer components | DMMA | 20 | 20 | 20 |
| | FA-511AS | 20 | 20 | 20 |
| | BA | 2 | 2 | 2 |
| | 2EHA | 2 | 2 | 2 |
| | GMA | 8 | 8 | 8 |
| Photoinitiator | Irg651 | 0.6 | 0.6 | 0.6 |
| Phenoxy resin | YP-50S | 16 | 16 | 16 |
| Epoxy resin | YD-128 | — | — | — |
| | YDF-170 | 74.4 | 74.4 | 74.4 |
| Impact modifier | BTA731 | 25.6 | 25.6 | 25.6 |
| Thermosetting agent | DICY | 5.6 | 5.6 | 5.6 |
| Curing aid | 2MZA-PW | 0.5 | 0.5 | 0.5 |
| Foaming agent | FN-80GSD | 2 | 3 | 4 |
| Filler | R-972 | 2 | 2 | 2 |
| Total weight of monomer | | 52 | 52 | 52 |
| components (A) | | | | |
| Total weight of epoxy resin (B) | | 74.4 | 74.4 | 74.4 |
| Total weight of thermoplastic | | 16 | 16 | 16 |
| resin (C) | | | | |
| B/A × 100 | | 143 | 143 | 143 |
| C/A × 100 | | 31 | 31 | 31 |
| Shape retention | | A | A | A |
| T-peel strength | Room temperature | 180 | 160 | 140 |
| | 80° C. | 230 | 210 | 190 |
| Shear strength | Room temperature | 24.9 | 24.3 | 20.4 |
| | 80° C. | 16.8 | 12.5 | 8.6 |
| Expansion rate | | 11% | 35% | 62% |

### Working Examples 20 to 22 and Comparative Example 2

Adhesive sheets were obtained in the same way as for Working Example 1, except that the formulations of the adhesive compositions were changed to those shown in Table 5. Additionally, as with Working Example 1, the obtained adhesive sheets were evaluated for shape retention, T-peel strength at room temperature and at 80° C., and shear strength at room temperature and at 80° C. The results are shown in Table 5. Note that, in Comparative Example 3, the fluidity of the adhesive sheet was high and handling as a solid was difficult. Therefore, it was not possible to conduct the evaluations for T-peel strength and shear strength according to the methods described above.

TABLE 5

| | | Working | Working | Working | Comparative |
|---|---|---|---|---|---|
| | | Example 20 | Example 21 | Example 22 | Example 2 |
| Monomer components | DMMA | 20 | 20 | 20 | 20 |
| | FA-511AS | 20 | 20 | 20 | 20 |
| | BA | — | — | — | — |
| | 2EHA | 4 | 4 | 4 | 4 |
| | GMA | 6 | 6 | 6 | 6 |
| Photoinitiator | Irg651 | 0.6 | 0.6 | 0.6 | 0.6 |
| Phenoxy resin | YP-50S | 16 | 16 | 16 | 16 |
| Epoxy resin | YD-128 | — | — | — | — |
| | YDF-170 | 44.2 | 91.2 | 142.4 | 182.4 |
| Impact modifier | BTA731 | 20.8 | 28.8 | 57.6 | 57.6 |
| Thermosetting agent | DICY | 4.6 | 7.03 | 11.2 | 14.06 |
| Curing aid | 2MZA-PW | 0.41 | 0.63 | 1 | 1.26 |
| Foaming agent | FN-100SD | — | — | — | — |
| | FN-80GSD | — | — | — | — |
| Filler | R-972 | 2 | 2 | 2 | 2 |
| Total weight of | | 50 | 50 | 50 | 50 |
| monomer components | | | | | |
| (A) | | | | | |
| Total weight of epoxy | | 44.2 | 91.2 | 142.4 | 182.4 |
| resin (B) | | | | | |
| Total weight of | | 16 | 16 | 16 | 16 |
| thermoplastic resin (C) | | | | | |
| B/A × 100 | | 88 | 182 | 285 | 365 |
| C/A × 100 | | 32 | 32 | 32 | 32 |
| Shape retention | | A | A | A | B |
| T-peel strength | Room temperature | 80 | 300 | 280 | — |
| | 80° C. | 120 | 280 | 230 | — |
| Shear strength | Room temperature | 35.3 | 34.1 | 38 | — |
| | 80° C. | 25.9 | 29.3 | 28.7 | — |

### Working Example 23

An adhesive sheet was obtained in the same way as for Working Example 1, except that the formulation of the adhesive composition was changed to that shown in Table 6. Additionally, as with Working Example 1, the obtained adhesive sheet was evaluated for shape retention, T-peel strength at room temperature and at 80° C., and shear strength at room temperature and at 80° C. The results are shown in Table 6.

TABLE 6

| | | Working |
|---|---|---|
| | | Example |
| | | 23 |
| Monomer components | DMMA | 20 |
| | FA-511AS | 20 |
| | BA | |
| | 2EHA | 4 |
| | GMA | 6 |
| Photoinitiator | Irg651 | 0.6 |
| Polyvinyl butyral resin | B-79 | 10 |
| Epoxy resin | YD-128 | — |
| | YDF-170 | 74.4 |
| Impact modifier | BTA731 | 25.6 |
| Thermosetting agent | DICY | 5.6 |
| Curing aid | 2MZA-PW | 1.5 |
| Filler | R-972 | 2 |
| Total weight of monomer | | 50 |
| components (A) | | |
| Total weight of epoxy resin (B) | | 74.4 |
| Total weight of thermoplastic resin (C) | | 10 |
| B/A × 100 | | 149 |
| C/A × 100 | | 20 |
| Shape retention | | A |
| T-peel strength | Room temperature | 110 |
| | 80° C. | 75 |
| Shear strength | Room temperature | 19.4 |
| | 80° C. | 11.4 |

Note that, in Table 6, “FA-513AS” is dicyclopentanyl acrylate.

1. An adhesive comprising:
an acrylic polymer;
an epoxy resin in an amount of 80 to 300 parts by mass per 100 parts by mass of the acrylic polymer;
at least one type of thermoplastic resin selected from the group consisting of a phenoxy resin and a polyvinyl butyral resin, in an amount of 15 parts by mass or greater per 100 parts by mass of the acrylic polymer; and
an epoxy resin curing agent; wherein
the acrylic polymer is a polymer of monomer components including a (meth)acrylic acid ester having a homopolymer Tg of 80° C. or higher, a nitrogen-containing monomer, and a crosslinking monomer having an epoxy group.

2. The adhesive according to claim 1, wherein an amount of the (meth)acrylic acid ester in the monomer components is from 20 to 60 mass %, based on an entire mass of the monomer components.

3. The adhesive according to claim 1, wherein an amount of the nitrogen-containing monomer in the monomer components is from 20 to 50 mass %, based on the entire mass of the monomer components.

4. The adhesive according to claim 1, further comprising a core-shell-type impact modifier.

5. The adhesive according to claim 1, further comprising a foaming agent.

6. The adhesive according claim 1, molded into a sheet shape.

7. The adhesive according to claim 6, further comprising on at least one face an airflow layer including an air-permeable material.

8. The adhesive according to claim 7, wherein the air-permeable material is selected from the group consisting of a woven fabric, a mesh, a knit, and a non-woven fabric.

9. A method for manufacturing a metal member assembly comprising the steps of:
forming a metal adhered body by disposing the adhesive according to claim 1 between at least a portion of a first metal member and a second metal member; and
obtaining a metal member assembly in which the first metal member and the second metal member are bonded to each other by heating the metal adhered body so as to cure the adhesive.

10. A metal member assembly comprising:
a first metal member;
a second metal member; and
a bonding member containing a cured product of the adhesive according to claim 1;
at least a portion of the bonding member being disposed between the first metal member and the second metal member, and bonding the first metal member and the second metal member to each other.

11. The adhesive according to claim 2, wherein an amount of the nitrogen-containing monomer in the monomer components is from 20 to 50 mass %, based on the entire mass of the monomer components.

12. The adhesive according to claim 2, further comprising a core-shell-type impact modifier.

13. The adhesive according to claim 3, further comprising a core-shell-type impact modifier.

14. The adhesive according to claim 2, further comprising a foaming agent.

15. The adhesive according to claim 3, further comprising a foaming agent.

16. The adhesive according to claim 4, further comprising a foaming agent.

17. The adhesive according claim 2, molded into a sheet shape.

18. The adhesive according claim 3, molded into a sheet shape.

19. The adhesive according claim 4, molded into a sheet shape.

20. The adhesive according claim 5, molded into a sheet shape.
